(19) United States
(12) Patent Application Publication
(10) Pub. No.: US 2007/0226260 A1
(43) Pub. Date: Sep. 27, 2007

(54) System and method for linking and managing audio, video, image, and text data on an iPOD

(76) Inventors: S. Mark Williams, Durham, NC (US); Andrew Carter Mace, Chapel Hill, NC (US); Nate O'Keefe, Durham, NC (US)

Correspondence Address: INTELLECTUAL PROPERTY / TECHNOLOGY LAW, PO BOX 14329, RESEARCH TRIANGLE PARK, NC, 27709, US

(21) Appl. No.: 11/702,671

(22) Filed: Feb. 6, 2007

Related U.S. Application Data
(60) Provisional application No. 60/771,434, filed on Feb. 9, 2006.

(51) Int. Cl. G06F 7/00; G06F 17/00

(52) U.S. Cl. 707/104.1

(57) ABSTRACT

A system and method are provided for converting, linking, and managing different types of data files relating to a common subject on an iPod. An iPod can be used to select a subject of interest to a user, and then play back audio data or video relating to the subject, or to display images or text relating to the subject. In this manner, an iPod may be used to access information in multiple data formats relating to subjects such as, for example, a travel guide, a nature and field guide, a restaurant guide, an entertainment guide, a medical reference guide, a professional training guide, or a study guide relating to a university course.

### BACKGROUND OF THE INVENTION

1. Field of the Invention

The present invention relates to an apparatus and a method for linking and managing disparate data types on a handheld device for displaying and playing back downloaded files, such as an iPod. More particularly, the invention relates to an apparatus and a method for converting, linking, and managing image, text, audio, and video data relating to a wide variety of informational categories on an iPod.

2. Related Art

The iPod, manufactured and sold by Apple Computer, Inc., has been a marketing phenomenon in recent years. The iPod has the capability of downloading certain types of data files, such as, for example, songs (audio data files) or a list of songs on an album (text files) or album art (image files), and then enabling a user to access the data files in the appropriate mode. For example, a user can select a downloaded song and then listen to the song using the iPod. Alternatively, the user can select a text file labeled with an album title and the iPod will display a textual list of the song titles from the album. As another example, the user can select the image file associated with the album, and the iPod will display a full-color, high-resolution image that is identical to that seen on the cover of the compact disc for the album, which is typically available in music stores.

Media types that can be purchased and played on an iPod include songs, audio books, television programs, short films, and music videos. The iPod can also display textual information or digital image data, such as a photograph taken by a digital camera. Typically, audio data files that are downloadable to an iPod generally use either a file format known as MP3, or one known as AAC. Video files that are downloadable to an iPod may use a file format known as MPEG-4. Image data files that contain digital, full-color photographs and that are downloadable to an iPod may use a bit-map file format known as RGB565. Text data files that are downloadable to an iPod may use a file format known as XML. In addition, the iPod is small, thin, and lightweight, so it can be easily carried by hand or in a shirt pocket. Finally, the iPod is reasonably priced for many consumers.

Because of its versatility in playing back and/or displaying disparate data types, including audio, text, image, and video, and because of its popularity, the iPod is a device that may lend itself to additional applications, relating to a variety of informational categories. In many instances, it would be advantageous to a user if an informational category associated with multiple files of more than one data type could be selected by category, or subject, rather than on a file-by-file basis. However, the iPod does not currently include this capability. Accordingly, the present inventors have recognized a need to enable users to access more than one data type in relation to the same information category.

### SUMMARY OF THE INVENTION

In one aspect, the invention provides a system configured for receiving downloadable files. The system is hand-holdable. The system includes a data port for receiving a transfer of at least a first downloadable file and a second downloadable file; a link module for linking the first downloadable file to the second downloadable file; an audio output port for playback of audio data; and a user interface for displaying visible data. Each of the first and second downloadable files includes a data type selected from the group consisting of audio data, text data, image data, and video data. The data type included in the first downloadable file is not the same as the data type included in the second downloadable file. The system may include an iPod.

Each of the at least first and second downloadable files may include data relating to a common subject. The common subject may be selected from the group consisting of a travel guide, a nature and field guide, a restaurant guide, an entertainment guide, a medical reference guide, a professional training guide, and a study guide relating to a university course.

The user interface may be configured to display an icon relating to the common subject and to enable a user to select the icon. When a user selects the icon, the user interface may be further configured to display selectable items. Each selectable item icon may relate to one of the at least first and second downloadable files. When a user selects a selectable item relating to a downloadable file that includes audio data, the system may be configured to play back the audio data via the audio output port. When a user selects a selectable item relating to a downloadable file that includes text data or image data, the system may be configured to display the text data or image data via the user interface. When a user selects a selectable item relating to a downloadable file that includes video data, the system may be configured to play back the video data via the user interface.

In another aspect, the invention provides a method of providing data to a user. The data includes at least two data types selected from the group consisting of audio data, text data, image data, and video data. The data relates to a common subject. The method includes the steps of deriving a first data file having a first data type from the data relating to the common subject; deriving a second data file having a second data type from the data relating to the common subject, combining the first and second data files into a single combined file; extracting the first and second data files from the combined file; downloading the first and second data files to a hand-holdable device; enabling a user to use the hand-holdable device to select the common subject; and, when the common subject is selected, providing access to the data included in each of the first and second data files via the hand-holdable device. The second data type is different than the first data type.

The method may further include the steps of deriving a third data file having a third data type from the data relating to the common subject; combining the third data file with the first and second data files into the single combined file; extracting the third data file from the combined file; downloading the third data file to the hand-holdable device; and when the common subject is selected, providing access to the data included in the third data file via the hand-holdable device. The third data type may be different than each of the first data type and the second data type. The method may further include the steps of deriving a fourth data file having a fourth data type from the data relating to the common subject, combining the fourth data file with the first, second, and third data files into the single combined file; extracting the fourth data file from the combined file; downloading the fourth data file to the hand-holdable device; and when the common subject is selected, providing access to the data included in the fourth data file via the hand-holdable device. The fourth data type may be different than each of the first, second, and third data types. The data files may be downloaded to an iPod, The step of providing access to the data may be performed using the iPod.

The common subject may be selected from the group consisting of a travel guide, a nature and field guide, a restaurant guide, an entertainment guide, a medical reference guide, a professional training guide, and a study guide relating to a university course. The method may further include the steps of displaying an icon relating to the common subject; enabling the user to select the icon; and, when the icon is selected, displaying selectable items, each selectable item relating to one of the first and second data files. The step of providing access to the data may include the steps of playing back the audio data when a selectable item relating to a downloadable file that includes audio data is selected; displaying the text data or image data when a selectable item relating to a downloadable file that includes text data or image data is selected; and playing back the video data when a selectable item relating to a downloadable file that includes video data is selected.

In yet another aspect of the invention, a storage medium for storing software for providing data to a user is provided. The data includes at least two data types selected from the group consisting of audio data, text data, image data, and video data. The data relates to a common subject. The software is readable by a microprocessor. The software includes instructions for causing a microprocessor to download a first data file; download a second data file; link the first data file to the second data file; enable a user to choose the common subject; and, when the common subject is chosen, provide access to the data included in each of the first and second data files. The first data file includes a first data type. The first data file includes data relating to the common subject. The second data file includes a second data type. The second data type is different than the first data type. The second data file includes data relating to the common subject.

The software may further include instructions for causing a microprocessor to download a third data file. The third data file may include a third data type. The third data type may be different than each of the first data type and the second data type. The third data file may include data relating to the common subject. The software may further include instructions for causing a microprocessor to download a fourth data file. The fourth data file may include a fourth data type. The fourth data type may be different than each of the first data type, the second data type, and the third data type. The fourth data file may include data relating to the common subject. The microprocessor may be configured to download the data files to an iPod. The microprocessor may be further configured to provide access to the data by using the iPod.

The common subject may be selected from the group consisting of a travel guide, a nature and field guide, a restaurant guide, an entertainment guide, a medical reference guide, a professional training guide, and a study guide relating to a university course. The software may further include instructions for causing a microprocessor to create a display of an icon relating to the common subject; enable the user to select the icon; and, when the icon is selected, create a display of selectable items. Each selectable item may relate to one of the first and second data files. The software may further include instructions for causing a microprocessor to play back the audio data when a selectable item relating to a downloadable file that includes audio data is selected; display the text or image data when a selectable item relating to a downloadable file that includes text data or image data is selected; and play back the video data when a selectable item relating to a downloadable file that includes video data is selected.

In still another aspect, the invention provides an iPod adapted for receiving linked downloadable files. Each of the linked files includes data that is related to a common subject. The iPod includes a data port for receiving a transfer of at least a first downloadable file and a second downloadable file; a link module for linking the first downloadable file to the second downloadable file; an audio output port for playback of audio data; and a user interface for displaying visible data. Each of the first and second downloadable files includes a data type selected from the group consisting of audio data, text data, image data, and video data. The data type included in the first downloadable file is not the same as the data type included in the second downloadable file. The user interface is configured to display an icon relating to the common subject and to enable a user to select the icon. When a user selects the icon, the user interface is further configured to display a plurality of selectable links. Each of the plurality of selectable links relates to one of the data types included in the at least two downloadable files. When a user selects a selectable link relating to a downloadable file that includes audio data, the iPod is configured to play back the audio data via the audio output port. When a user selects a selectable link relating to a downloadable file that includes text data or image data, the system is configured to display the text data or image data via the user interface. When a user selects a selectable link relating to a downloadable file that includes video data, the system is configured to play back the video data via the user interface.

In yet another aspect, the invention provides a method of providing data via an iPod to a user. The data includes at least two data types selected from the group consisting of audio data, text data, image data, and video data. The data relates to a common subject. The method includes the steps of deriving at least a first data file having a first data type and a second data file having a second data type different from the first data type from the data relating to the common subject; combining the at least first and second data files into a single combined file; extracting the at least first and second data files from the combined file; downloading the at least first and second data files to the iPod; displaying an icon relating to the common subject; enabling a user to use the iPod to select the icon; and when the icon is selected, displaying selectable links. Each selectable link relates to one of the downloaded data files. When a selectable link relating to a downloaded data file that includes audio data is selected, the method further includes the step of playing back the audio data. When a selectable link relating to a downloaded data file that includes text data or image data is selected, the method further includes the step of displaying the text data or image data. When a selectable link relating to a downloaded file that includes video data is selected, the method further includes the step of playing back the video data.

In still another aspect of the invention, a storage medium for storing software for providing data via an iPod to a user is provided. The data includes at least two data types selected from the group consisting of audio data, text data, image data, and video data. The data relates to a common subject. The software is readable by a microprocessor. The software includes instructions for causing a microprocessor to download at least a first data file having a first data type and a second data file having a second data type; combine the at least first and second data files into a single combined file; use the combined file to install the at least first and second data files onto the iPod; enable a user to use the iPod to select an icon relating to the common subject; and when the icon is selected, provide access to the data included in each of the at least first and second data files via the iPod. The second data type is different than the first data type. Each of the at least first and second data files includes data relating to the common subject.

### BRIEF DESCRIPTION OF THE DRAWINGS

FIG. 1 is a flow diagram that illustrates a conversion process for converting a reference volume into an iPod title according to a preferred embodiment of the invention.

FIG. 2 is a flow chart that illustrates a process for linking and managing disparate data types relating to a common subject according to a preferred embodiment of the invention.

FIG. 3 is a flow diagram that illustrates a conversion process for converting the contents of a reference into iPod-ready files and then into a single data file having more than one data type according to a preferred embodiment of the invention.

FIG. 4 is a block diagram of a system for linking and managing disparate data types according to a preferred embodiment of the invention.

FIG. 5 shows how a user can select an iPod title, as generated by a system according to a preferred embodiment of the invention, to produce an image display relating to the subject of the selected iPod title.

FIG. 6 shows an exemplary set of menus of subtopics and user options relating to one of the selected iPod title of FIG. 5.

FIG. 7 shows an exemplary selection of general interest reference titles that may be implemented on an iPod using a process according to a preferred embodiment of the invention.

FIG. 8 shows an exemplary set of menus of subtopics and user options relating to one of the example reference titles shown in FIG. 6.

FIGS. 9 and 10 show exemplary reference titles relating to specialized fields of study as implemented on an iPod using a process according to a preferred embodiment of the invention.

FIG. 11 shows a selection of exemplary reference titles relating to a medical references and study guides for medical students that may be implemented on an iPod using a process according to a preferred embodiment of the invention.

FIGS. 12A and 12B show an exemplary educational flash card tool designed for children that may be implemented on an iPod using a process according to a preferred embodiment of the invention.

FIGS. 13A and 13B show an exemplary educational flash card tool designed for medical students that may be implemented on an iPod using a process according to a preferred embodiment of the invention.

FIGS. 14A-14C show an exemplary scrollable map tool that may be implemented on an iPod using a process according to a preferred embodiment of the invention.

FIGS. 15A-15C show an exemplary zoomable set of images derived from a medical reference title that may be implemented on an iPod using a process according to a preferred embodiment of the invention.

### DETAILED DESCRIPTION OF THE INVENTION

The present inventors have recognized that the capability of an iPod to download disparate data types, including audio data, image data, text data, and video data, can enable the iPod to be used for a wide variety of applications for providing information access to users on almost any subject. Conventional use of the iPod has typically included songs, audio books, television programs, short films, and music videos. However, the present invention enables a user to download and access additional reference types and subject matter categories, including, for example: travel guides; nature and field guides; restaurant and entertainment guides; medical and professional reference titles; higher education supplementary media, such as flashcards, quizzes and practice examinations, and study guides; and professional training guides. In addition, the present invention contemplates providing such access via an iPod for virtually any type of reference or subject. In a preferred embodiment, the invention is designed for optimal use on fourth- and fifth-generation iPods (also known as the “photo” iPod and the “video” iPod), as well as the iPod Nano; i.e., any iPod that includes a color display.

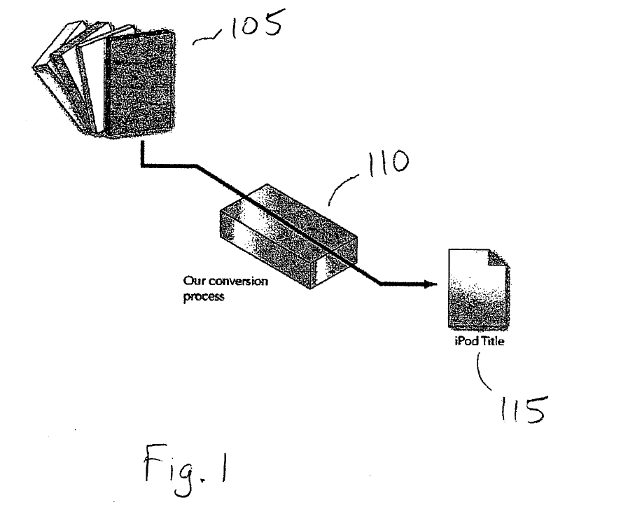

Referring to FIG. 1, a flow diagram that illustrates a conversion process for converting a reference volume into an iPod title according to a preferred embodiment of the invention is shown. An educational, edutainment, or reference title 105 may typically be available in a traditional format, such as a book, a film, or a recording, and may or may not also be available in the appropriate file format. Conventionally, the iPod is configured to download any file having an MP3, MPEG4, RGB 565, or XML file format, and then to play back or display the information, depending on the data type. However, many reference titles may include information that can be presented using two or more data types. With conventional iPod files, each file can include only one data type. Therefore, if a single subject or reference title includes data having two or more types, two or more corresponding iPod files would be required. Furthermore, the conventional use of an iPod does not provide any way to link the two or more iPod files.

Accordingly, the present invention uses a conversion process 110 to take traditional multimedia content from a publisher and to convert the content into iPod-ready files. Further, the present invention uses the conversion process 110 to convert the two or more data files of different data types relating to a single reference title 105 into an “iPod title” 115. The iPod title 115 is a single data file that includes all of the different data types relating to the same subject, i.e., the reference title 105. In a preferred embodiment, the iPod title 115 is referred to as an iPod Reference Title (IRT).

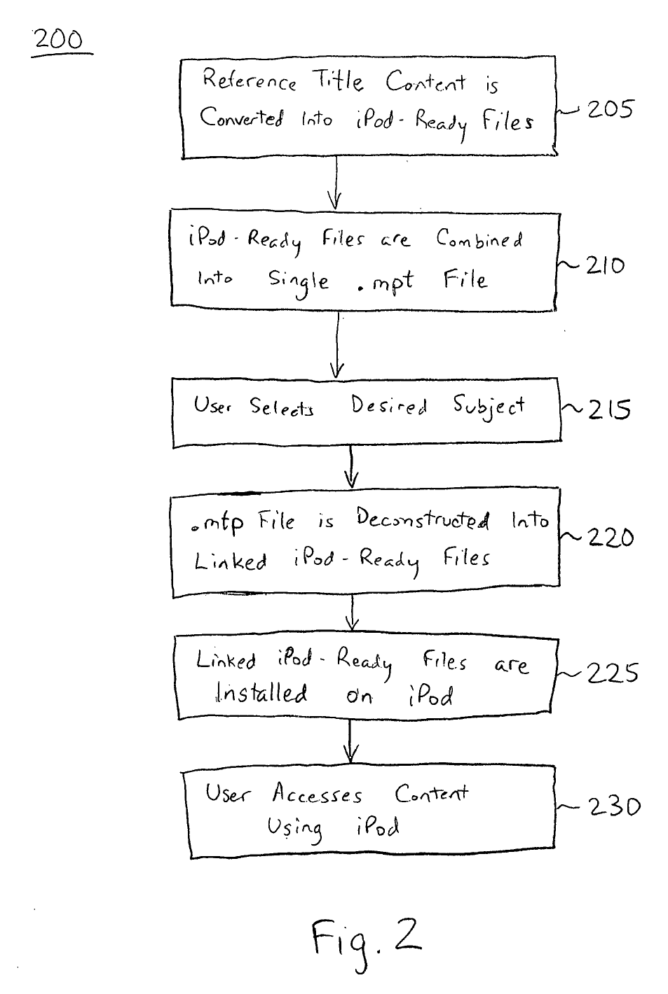

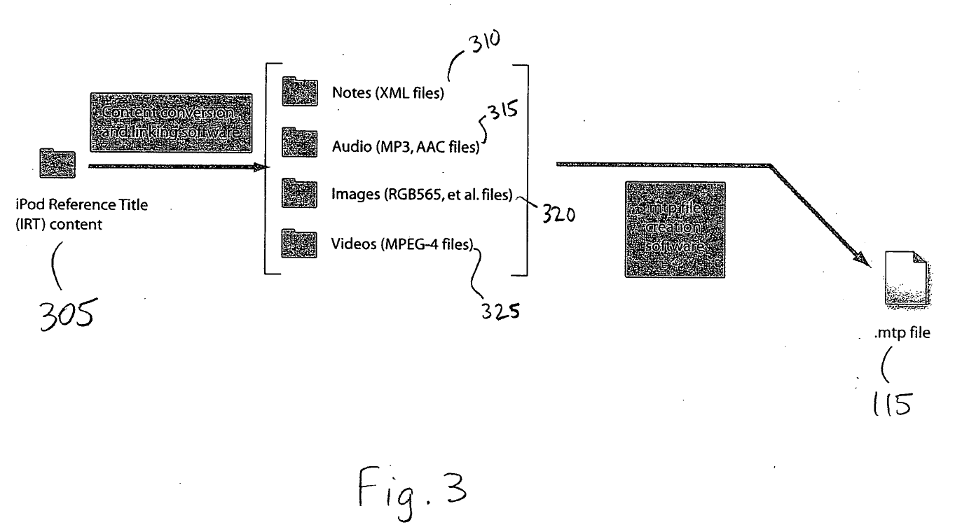

Referring to FIGS. 2 and 3, a flow chart 200 and flow diagram 300 for the conversion process 110 is shown. The first step 205 is to convert the content from the reference title 105 (also shown as IRT content 305) into digital data in the appropriate respective iPod file format. The result of the conversion in step 205 will be one iPod-ready file for each data type that is included in the information content associated with the reference title 105. So, for example, a reference title 105 that includes text, audio, image, and video content will yield iPod-ready files of four separate types 310, 315, 320, and 325 as a result of the digital conversion of step 205.

In addition, the step 205 of converting content from the reference title 105 into iPod-ready files may include the creation of custom images, including either thumbnail images or full-size images, that are related to the reference title 105. In this manner, a icon or a symbol for the reference title 105 may be created, in order to provide a selectable option for the iPod user who wishes to access the content of that reference title.

Then, in step 210, all of the iPod-ready files associated with a single reference title 105 are converted into binary code and combined into a single data file, i.e., IRT 115. The IRT 115 will preferably be labeled with the “.mtp” file extension to denote a “modality title package” file. By combining all of the disparate data types into a single file, the content is effectively linked together. The IRT file 115 can preferably be labeled in a manner to indicate to a user the subject matter of the reference title 105.

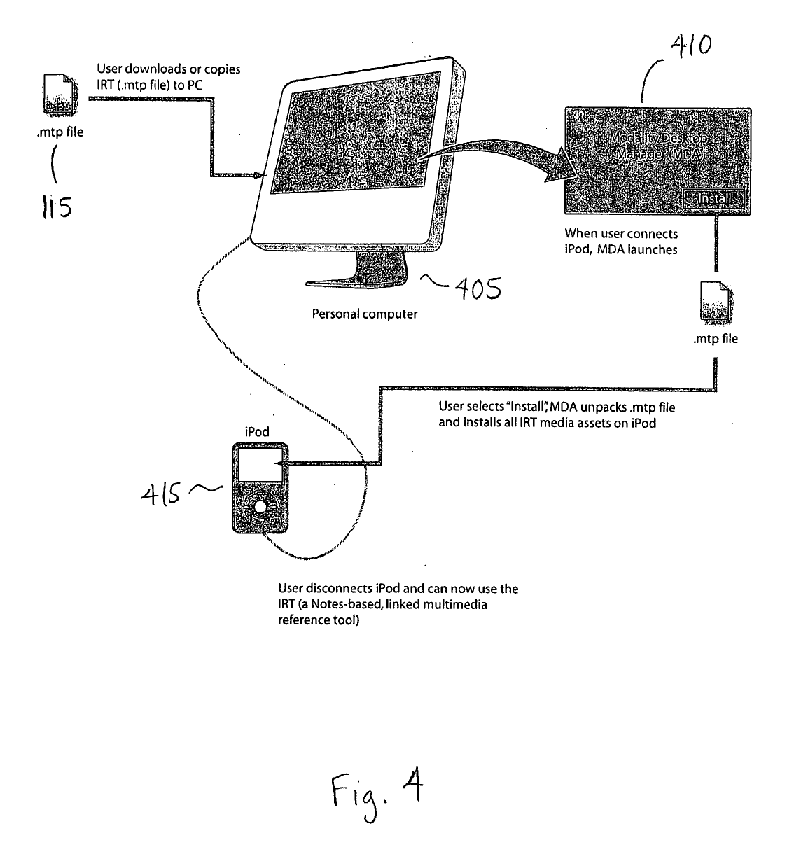

Referring also to FIG. 4, at step 215, a user desiring to access the reference title 105 on the user's iPod obtains a copy of the IRT file 115 associated with the reference title 105. The user may obtain the IRT file 115, for example, by purchasing the IRT file 115 via the Internet or through a traditional commercial outlet. The user downloads the IRT file 115 onto a personal computer 405. The personal computer 405 is configured to include a software module 410 that is designed for processing the IRT file 115. In a preferred embodiment, the software module 410 is known as the Modality Desktop Application (MDA).

At step 220, the MDA 410 reads the IRT file 115 and deconstructs the embedded media assets from the file 115 into the constituent iPod-ready files. Then, at step 225, the MDA 410 installs all of the iPod-ready files in an iPod 415 that is connected to the personal computer 405. The installation is effected by writing the iPod-ready files directly to an appropriate iPod database or to the Notes folder on the iPod 415. More particularly, the installation makes use of three iPod database files: iTunesDB for audio and video, ArtworkDB for album art work, and Photo Database for photographs. Each of these ipod databases is updated with specific information about each new entry, including, for example, a unique identification, byte offsets and byte lengths for RGB565 data, and title strings. In addition, other iPod system files, such as SysInfo, are read to determine the type of iPod upon which the installation is occurring. Each of the photo (4^{th}-generation) iPod, the video (5^{th}-generation) iPod, and the iPod Nano uses different and mutually incompatible image data formats, so the data transfer must take the destination iPod type into account. To complete the installation, text-based or Notes files are copied to the Notes folder on the iPod.

Finally, at step 230, the user can eject the iPod 415 and then use the iPod 415 as desired. Having completed the installation, the user is then able to access all of the data content associated with the original reference title 105 by navigating to the item of interest and selecting it. Upon selection, the user will be provided with a text description of the reference title 105 and selectable links to each of the individual data types that are associated with that reference title 105.

The MDA 410 is preferably implemented by the use of one or more general purpose computers 405, such as, for example, a Sun Microsystems F15k, an Apple Macintosh, or a typical personal computer manufactured by Dell, Gateway, or Hewlett-Packard. The computer 405 on which the MDA 410 is implemented can include a microprocessor. The microprocessor can be any type of processor, such as, for example, any type of general purpose microprocessor or microcontroller, a digital signal processing (DSP) processor, an application-specific integrated circuit (ASIC), a programmable read-only memory (PROM), or any combination thereof. The computer 405 may use its microprocessor to read a computer-readable medium containing software that includes instructions for carrying out one or more of the functions of the MDA 410, as described above. In a preferred embodiment, this software is written in the C language. Exemplary code that is included in the MDA 410 in a preferred embodiment of the invention is shown in an appendix to this patent specification.

The computer 405 can also include computer memory, such as, for example, random-access memory (RAM). However, the computer memory of the computer 405 can be any type of computer memory or any other type of electronic storage medium that is located either internally or externally to the computer 405, such as, for example, read-only memory (ROM), compact disc read-only memory (CDROM), electro-optical memory, magneto-optical memory, an erasable programmable read-only memory (EPROM), an electrically-erasable programmable read-only memory (EEPROM), or the like. The computer 405 can also include a database. The database can be any type of computer database for storing, maintaining, and allowing access to electronic information stored therein. The computer 405 preferably resides on a network, such as a local area network (LAN), a wide area network (WAN), or the Internet.

The MDA 410 and the use of the IRT file 115 also enable the ability to provide digital rights management to the reference title content. For example, the IRT file 115 may contain some form of copy protection or encryption which can only be read or unencrypted by the MDA 410.

The MDA 410 provides integration with the conventional database formats that are currently used by the iPod. Because of this integration, in a preferred embodiment of the invention, installation of the linked iPod-ready files by using the MDA 410 can be performed in a simple “one-click” user operation. In this manner, the present invention provides the advantage that installation and management of disparate media types on an iPod is simplified and easily understood by typical iPod users.

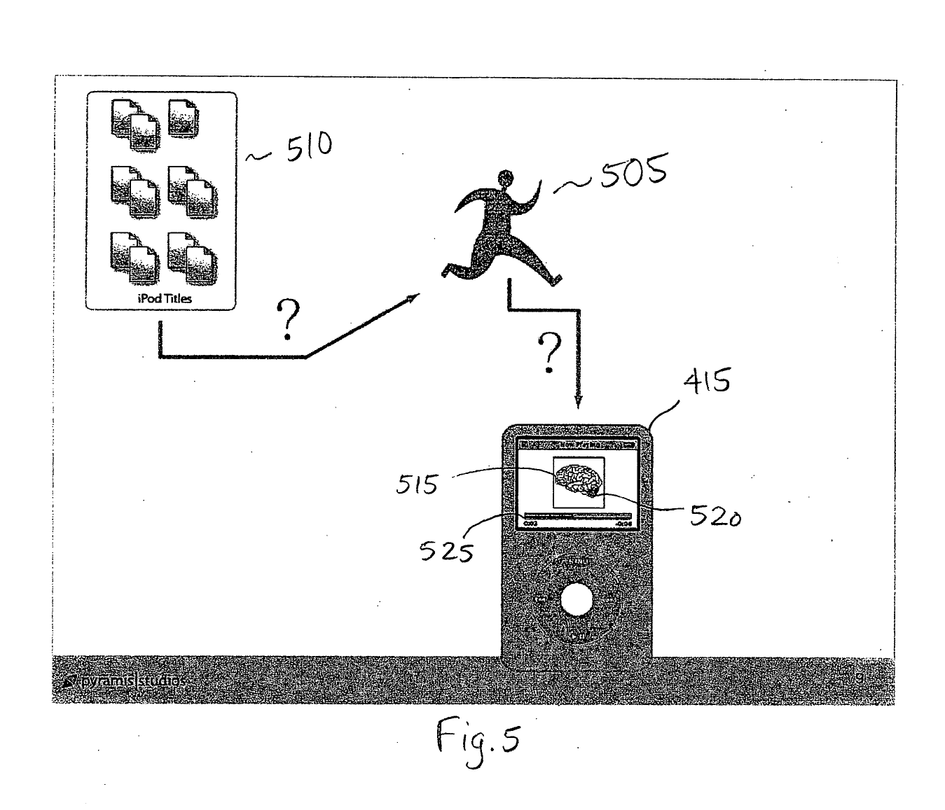

Referring to FIG. 5, an example of how a user can select an IRT to produce an image display together with an audio playback is shown. User 505 is presented with a selection of IRTs 510. The user 505 selects an IRT relating to a study guide for the anatomy of the brain. As a result of this selection, the user's iPod 415 displays an image 515 of the brain, with a highlighted portion 520. In addition, as indicated by the timing bar 525, the iPod 415 plays back an audible pronunciation of the specific name for the highlighted brain area 520.

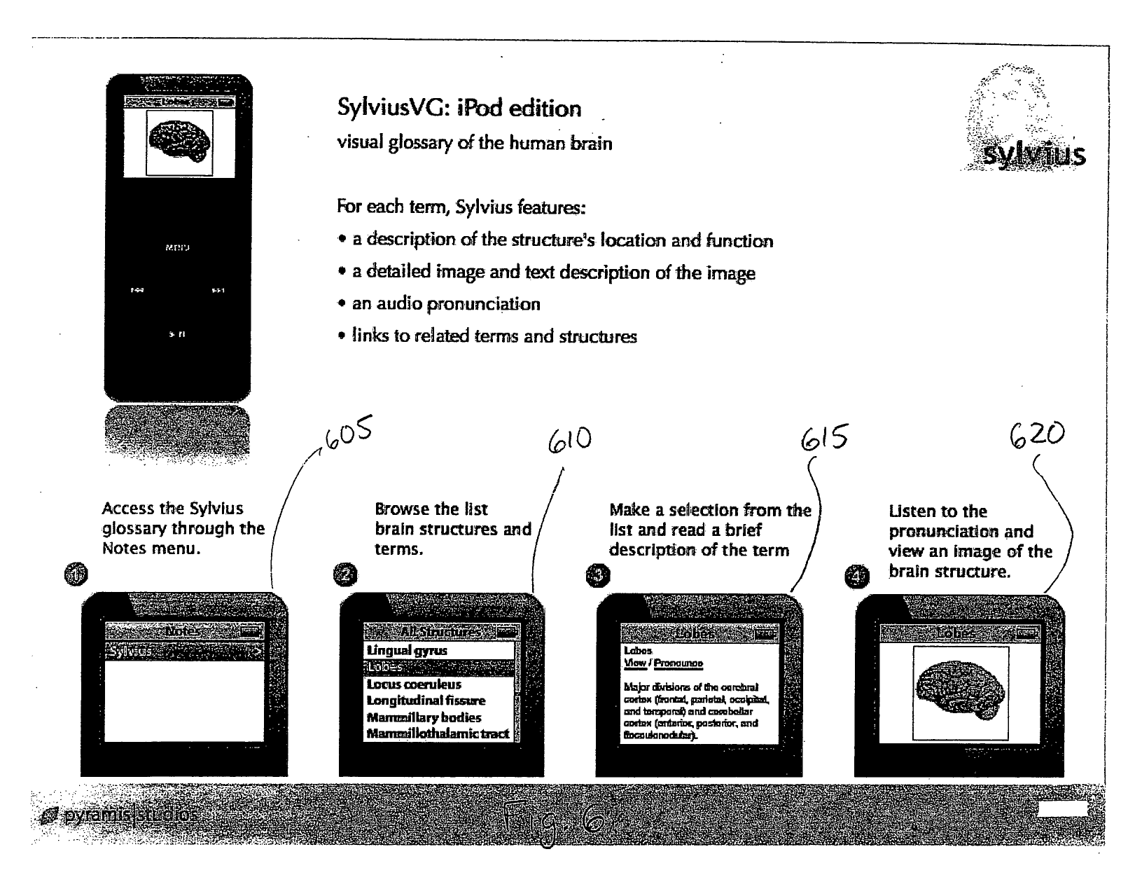

Referring to FIG. 6, an illustration of how a typical user could navigate through the menus and content relating to the IRT 510 of FIG. 5 is shown. At step 605, the IRT 510 is selected through the Notes menu on the iPod. Having selected the brain glossary entitled “Sylvius”, a scrollable list of brain structures and terms is presented at step 610. Then, at step 615, the term “Lobes” is selected, and a brief textual description of the term is provided. In addition, two selectable links are provided: one link enables a user to obtain a view of an image of the selected brain structure, as shown in step 620; and the other link enables the user to listen to the pronunciation of the selected term.

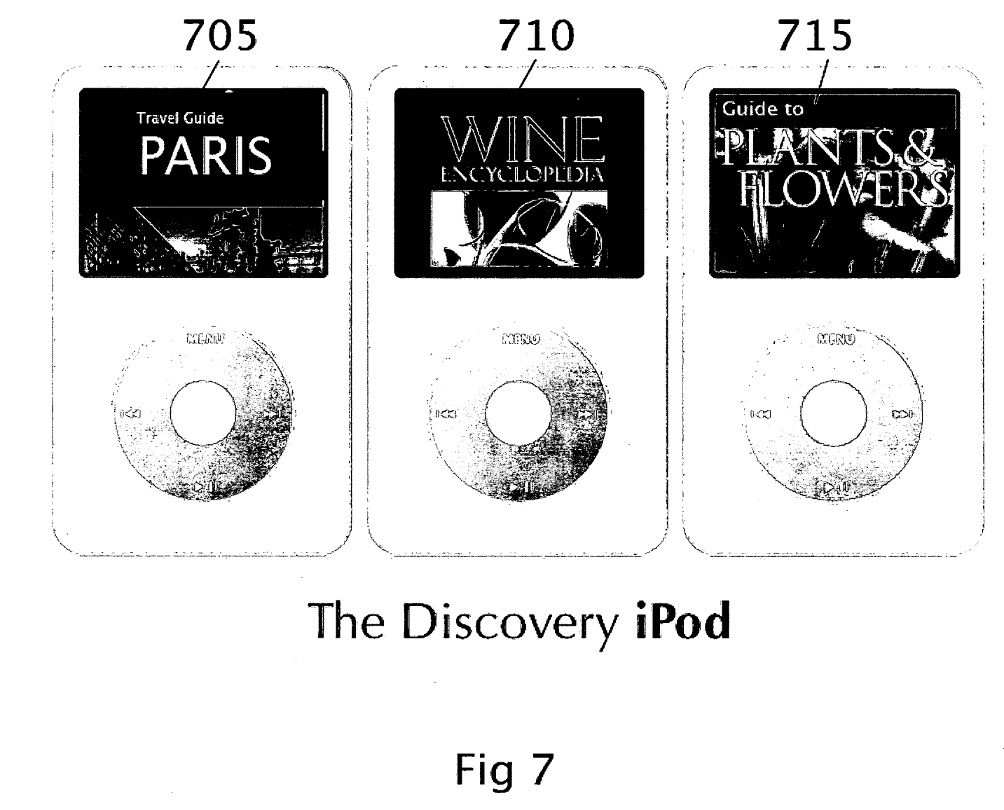

Referring to FIG. 7, three examples 705, 710, 715 of IRTs are shown. In example 705, the iPod display shows an image of a book cover for a Paris travel guide. In example 710, the iPod display shows an image of a book cover for a wine encyclopedia. In example 715, the iPod display shows an image of a book cover for a plants and flowers compendium.

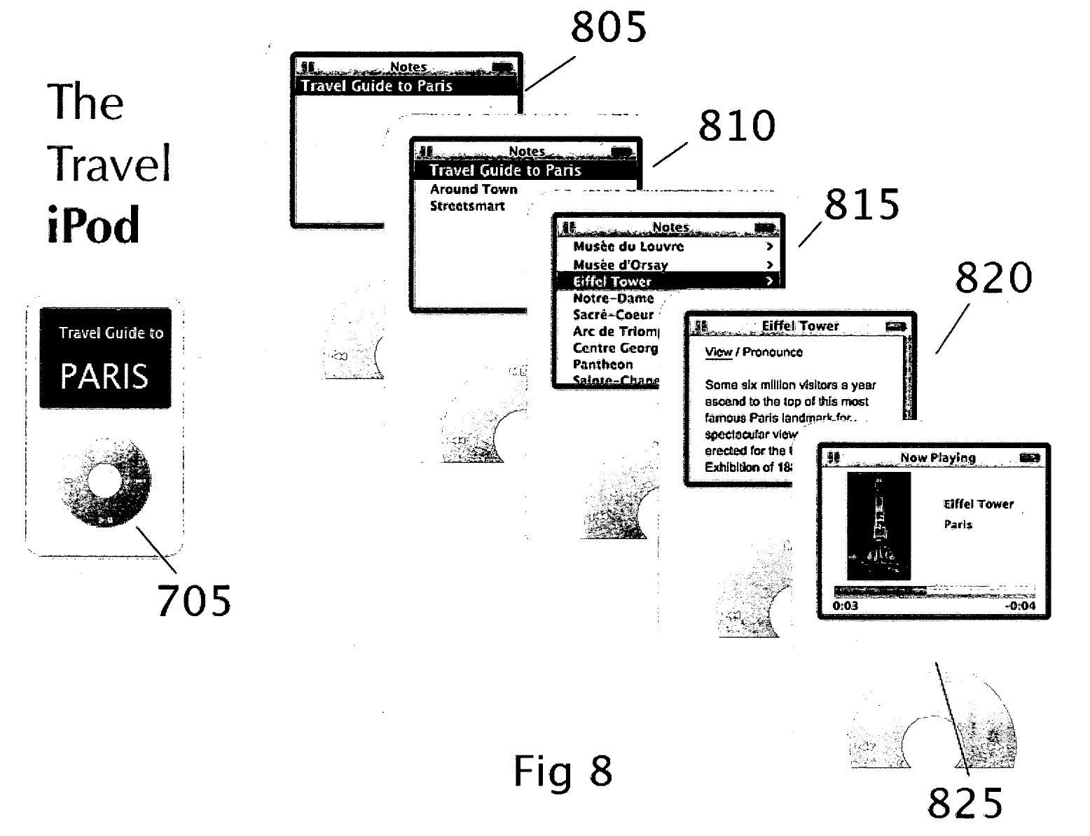

Referring to FIG. 8, a cascading set of textual subtopic areas is shown to illustrate how a user can navigate through the content of an exemplary IRT. A user has selected the Paris travel guide, i.e., example 705. In the first screen 805, the book title is shown as a text entry. After selecting the book, the next text menu 810 includes the titles of the three major divisions of the travel guide. Upon selecting the first item in menu 810, i.e., “Travel Guide to Paris”, the next text menu 815 lists ten popular tourist attractions in Paris. The user is free to select any one of the ten, and in this example, the user selects the Eiffel Tower. This selection yields screen 820, which provides a textual description of the Eiffel Tower. Screen 820 also enables the user to select the “View” or “Pronounce” options. After selecting “View”, the iPod screen displays a digital, full-color picture of the Eiffel Tower, as illustrated in screen 825. After selecting “Pronounce”, the iPod will play back an audible pronunciation of the words “Eiffel Tower”.

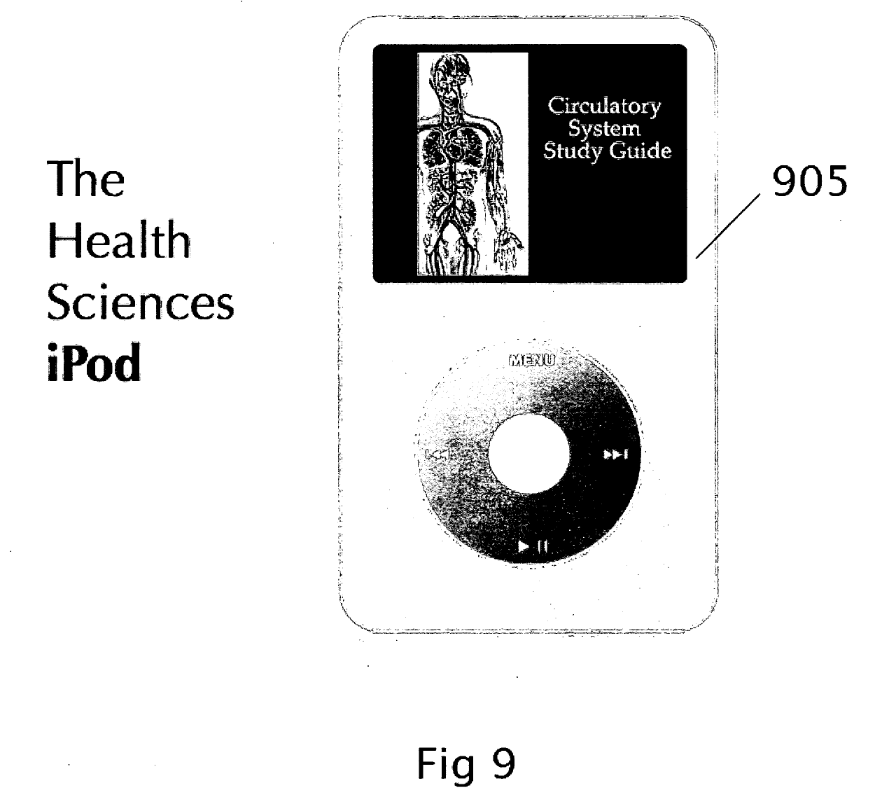

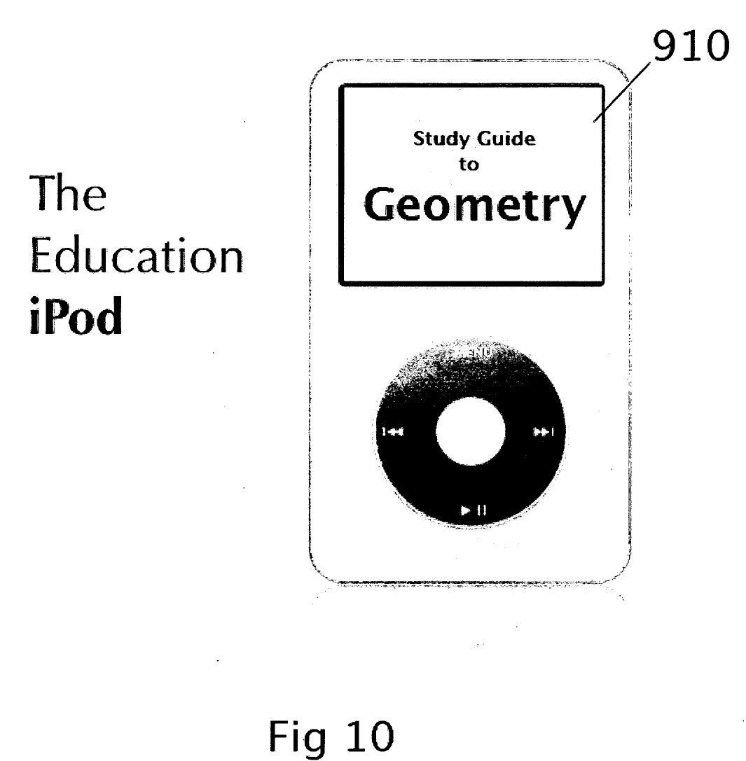

Referring to FIGS. 9 and 10, additional exemplary IRTs is shown. In example 905, a study guide for the circulatory system has been downloaded onto the iPod. This study guide is likely to be useful to medical students who are taking a course relating to the circulatory system. Because the iPod is small and lightweight, it is much easier for the student to have the study guide accessible via the iPod than to carry the book of the same title. In example 910, a study guide for middle school-level geometry is shown.

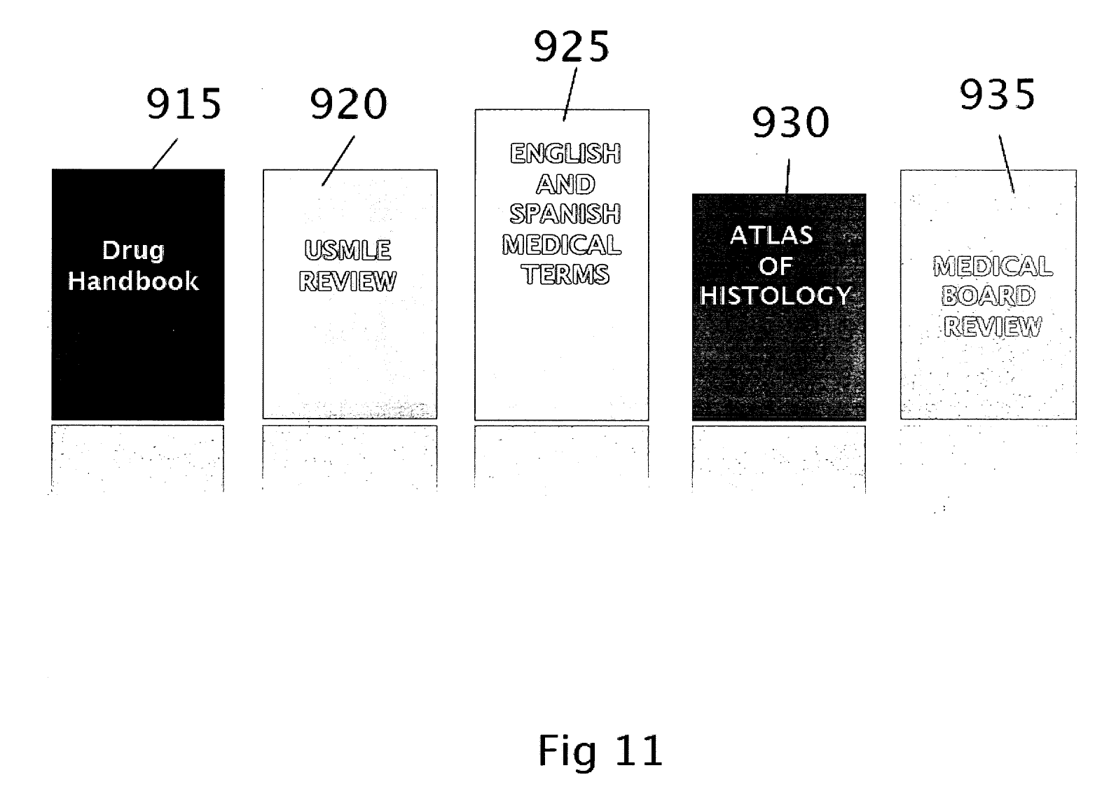

Referring to FIG. 11, examples of traditional reference titles 105 that are suitable for conversion to IRTs are shown. In example 915, a drug handbook, a reference manual for practicing physicians, is shown. Example 920 is a reference entitled “USMLE Review”, which is a study guide for a standardized medical examination. Example 925 is an English/Spanish conversion reference for medical words and phrases, which is useful to many doctors who have patients that speak one or the other of these languages. Example 930 is entitled “Atlas of Histology”, another medical reference. In this example, the reference includes a compact disk that includes image data to illustrate certain body structures in a pictorial fashion. Example 935 is a study guide for medical students facing standardized examinations.

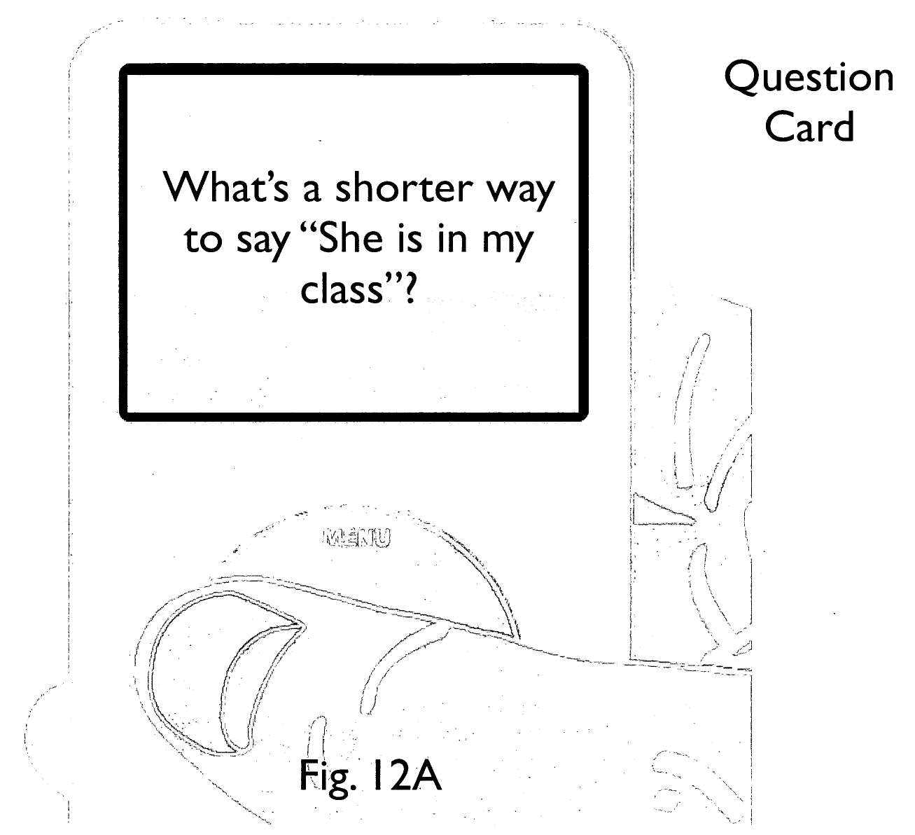

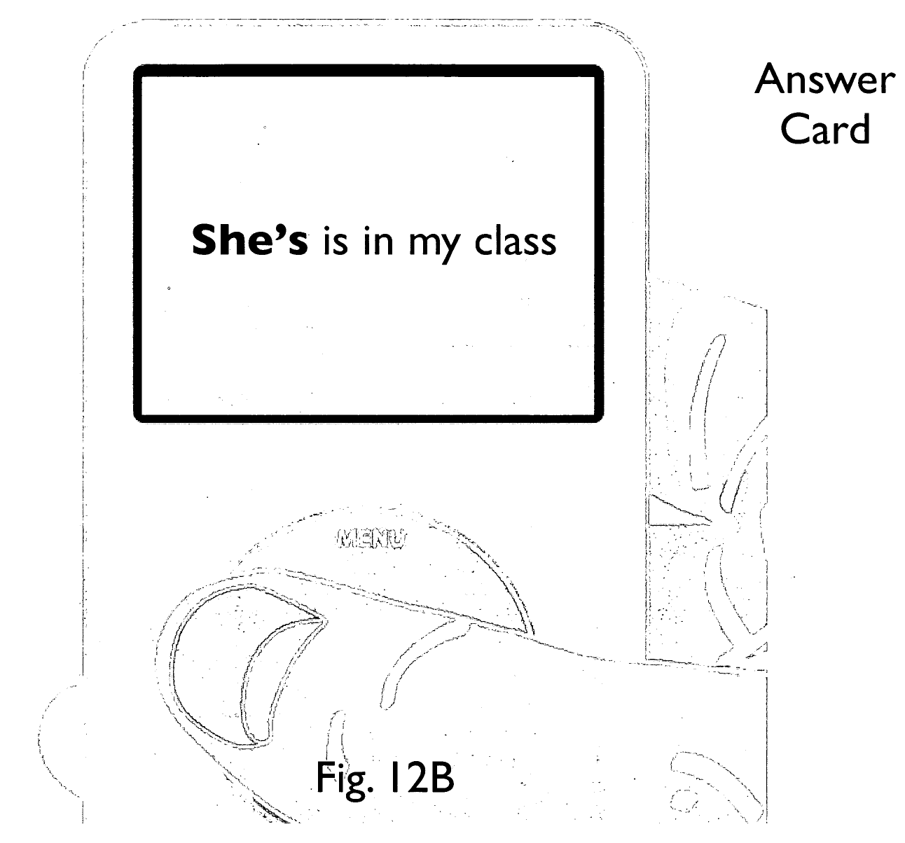

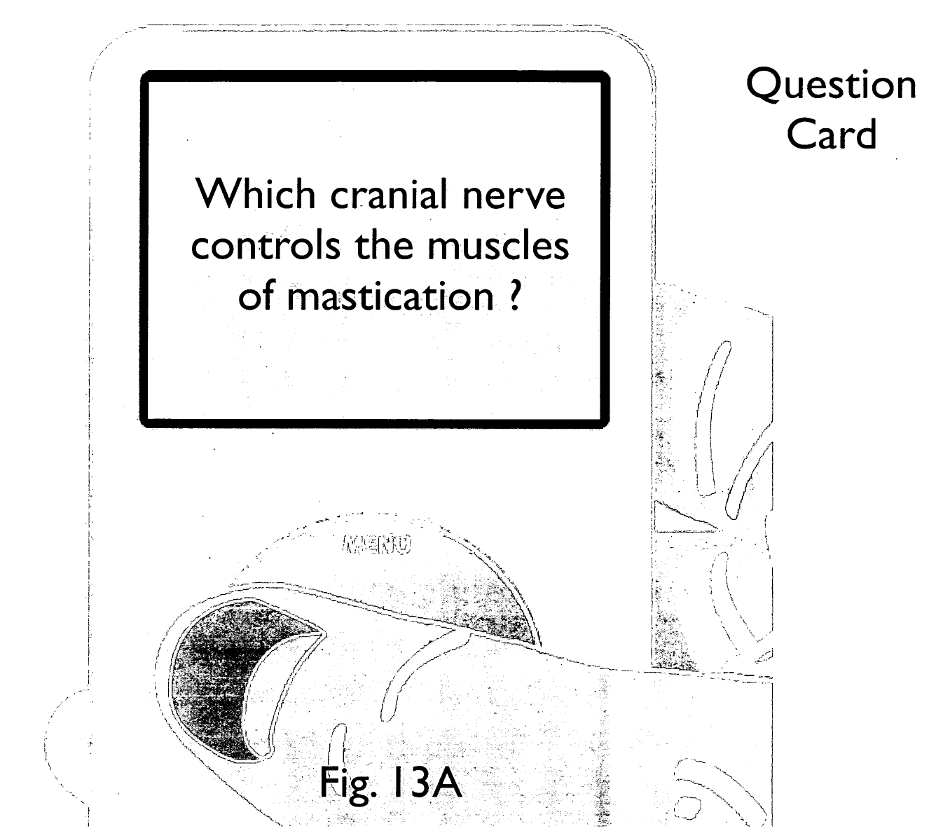

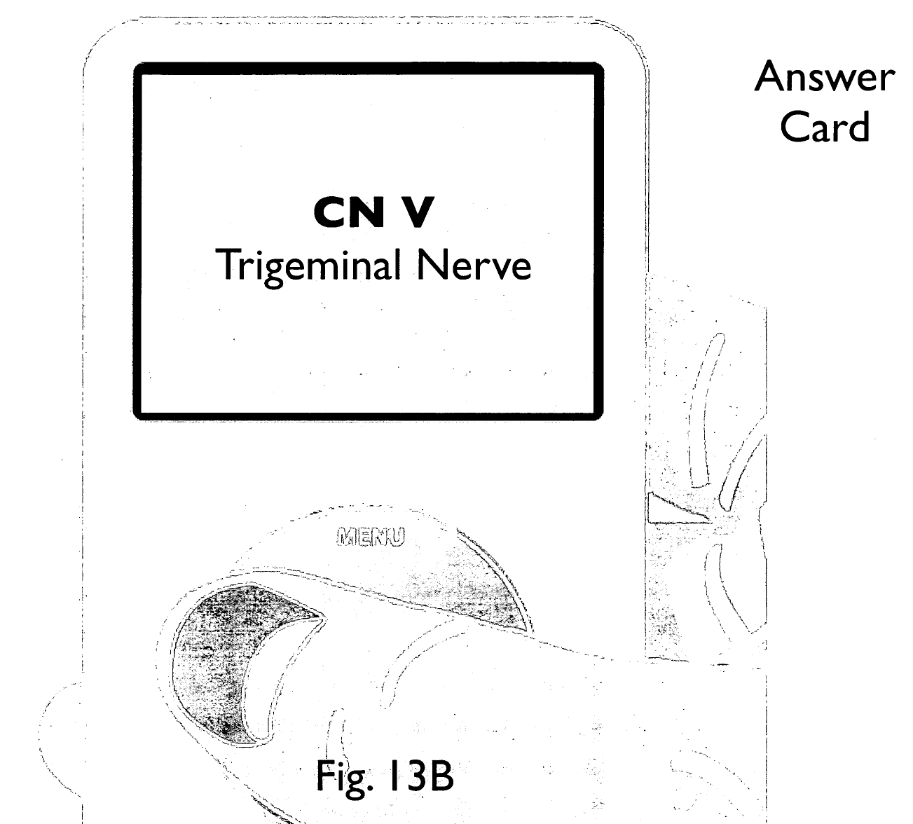

Referring to FIGS. 12A and 12B, an exemplary educational flash card tool for children is shown. In this example, the flash cards are implemented on the iPod 415 as a set of images that show the user a question card followed by an answer card. The cards are graphically formatted to provide the user with a very fluid experience of clicking through a series of questions and answers by simulating physical flash cards. Referring to FIGS. 13A and 13B, another example of educational flash cards, this example being designed for medical students, is illustrated. The flash card implementation can be used for any appropriate subject matter and any target audience. In addition, in a preferred embodiment of the invention, custom thumbnail images of each flash card may be delivered by the MDA 410. By using a set of custom thumbnail images, text and reference numbers can be added to assist users in navigating the flash cards. In another feature of the preferred embodiment of the invention, the MDA 410 enables a user to randomize the order of appearance of the flash cards by simply clicking a button in the MDA 410 while the iPod 415 is attached.

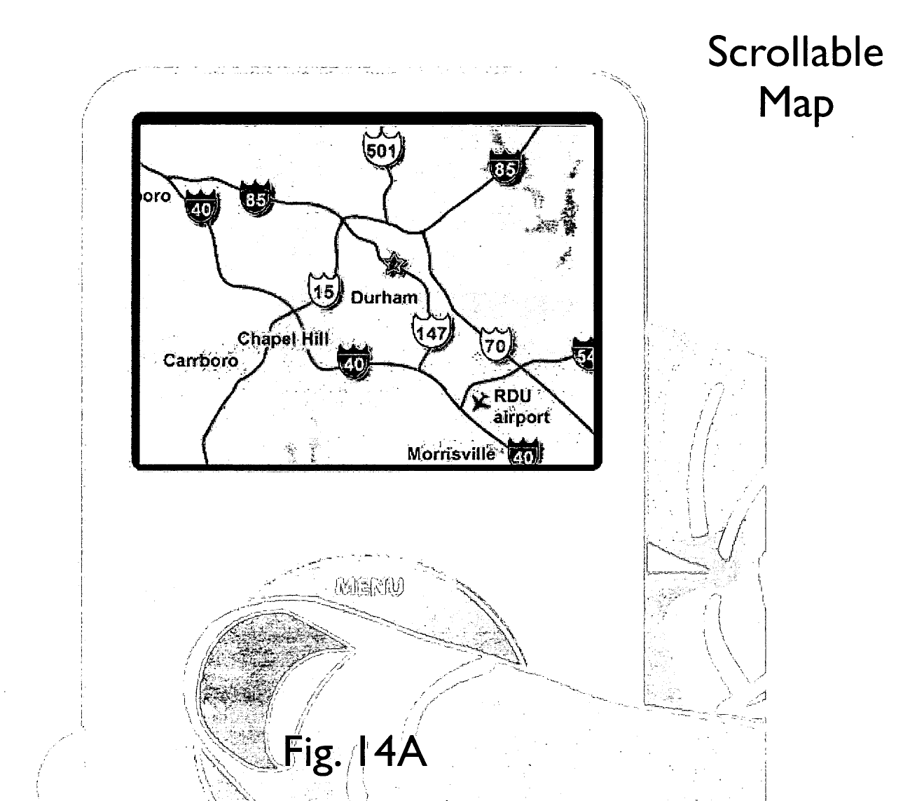

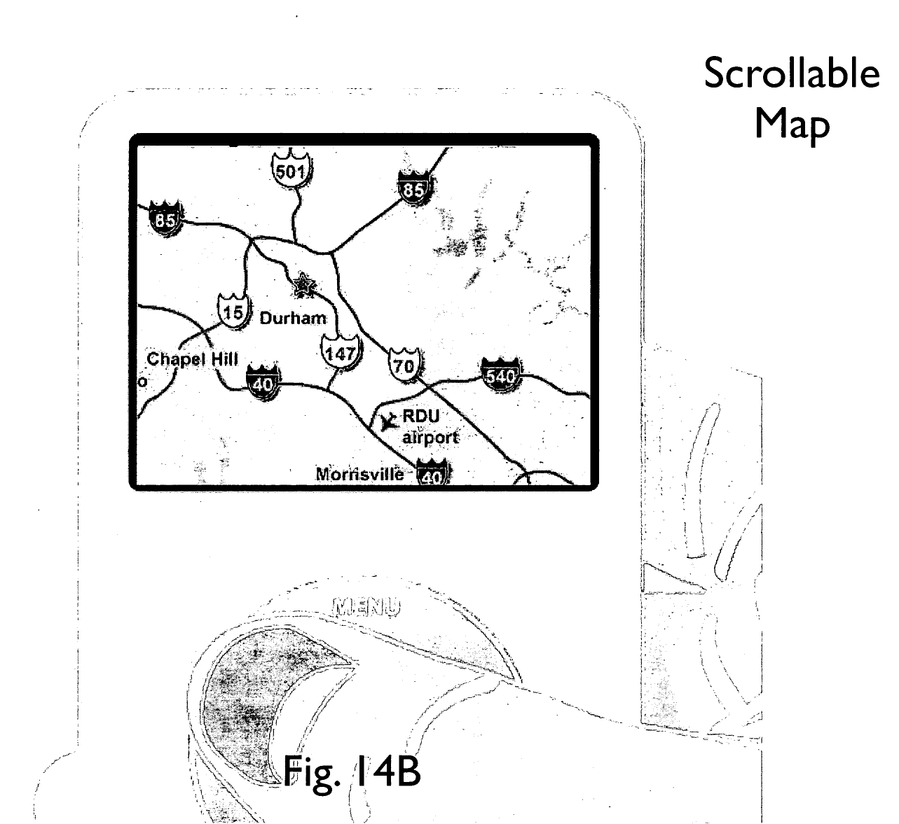

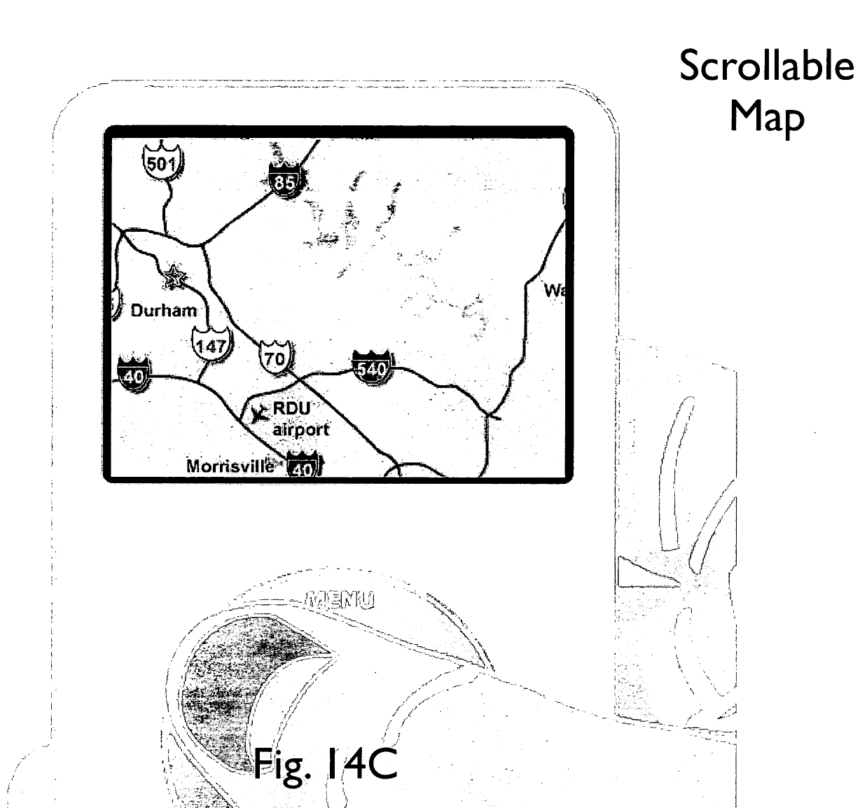

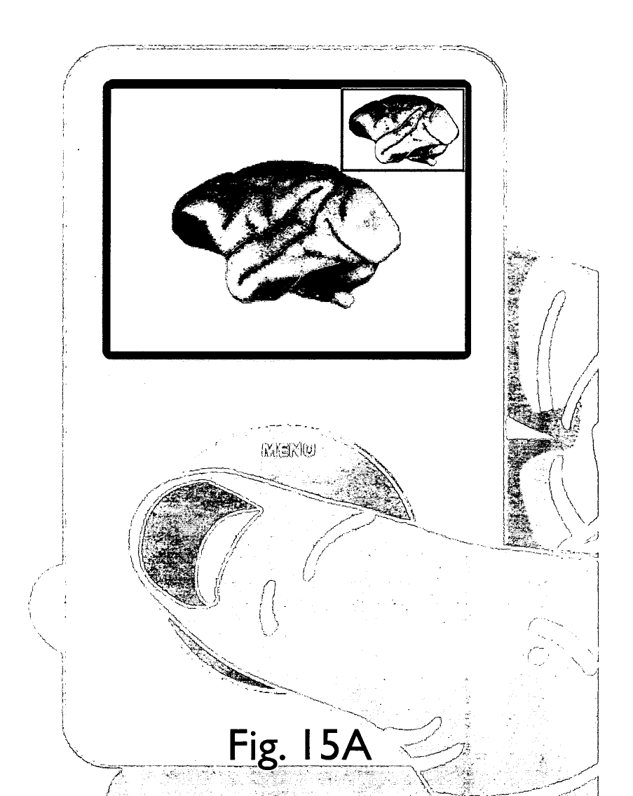

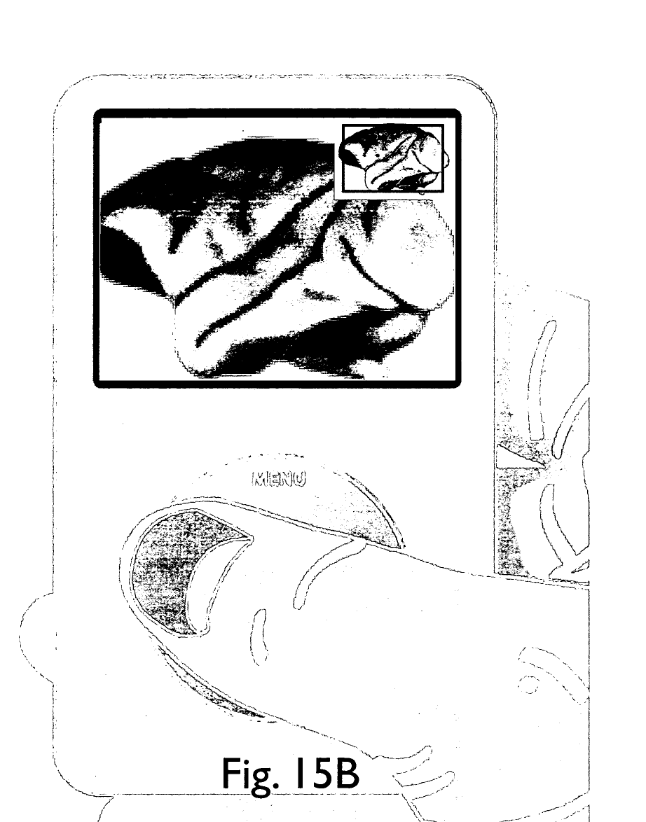

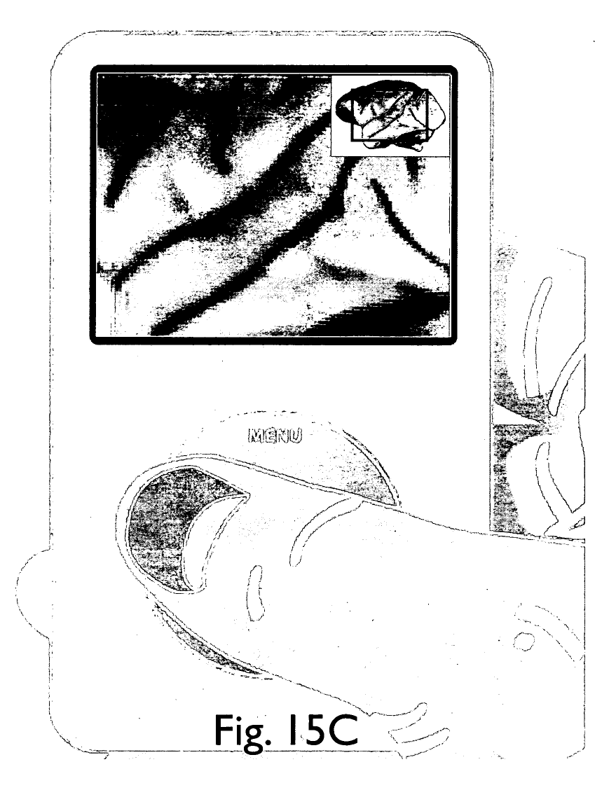

Referring to FIGS. 14A-14C and FIGS. 15A-15C, in a preferred embodiment of the invention, images included in an IRT file can be implemented to be scrollable and/or zoomable. In FIGS. 14A-14C, a map of a section of central North Carolina is shown at a selected level of resolution. In order to show the desired resolution, only a portion of the map may be displayed on the iPod 415 at any given time. Accordingly, the MDA 410 enables the user to scroll across the map, from the west to the east, while enabling the user to locate several important landmarks, such as cities, towns, and an airport. In FIGS. 15A-15C, a pictorial depiction of the brain is shown. In order to obtain a closer view of a user-selected region of the brain, the MDA 410 enables the user to zoom in on the selected region. The scrollability and zoomability features may be implemented for any appropriate subject matter and any desired target audience.

An appendix to this specification is attached. The appendix includes software code written in the C programming language and used by the MDA 410; a software architecture for the MDA 410; a file format specification for files that are processed by the MDA; and an iPod Note Reader User Guide.

In a preferred embodiment of the invention, the platform of the iPod may be modified to provide a more user-friendly environment for accessing linked files of disparate data types that relate to a common subject. In particular, the iPod uses an operating system that is run by software, i.e., a computer program. The iPod operating system software can be modified to include an ability to identify a reference title 105 to which a given iPod-ready file is related, independent of the data type of that iPod-ready file. For example, the iPod-ready file can include header information, and a portion of the header information can include a source reference identifier that uniquely links the file to the source reference title. The iPod operating system software can use the source reference identifiers to determine all files that have been downloaded to the iPod which are derived from the same source reference title 105. By modifying the iPod operating system software in the foregoing manner, the management of linked files related to a common subject is facilitated and enables simplified iPod navigation for users.

While the present invention has been described with respect to what is presently considered to be the preferred embodiment, it is to be understood that the invention is not limited to the disclosed embodiments. To the contrary, the invention is intended to cover various modifications and equivalent arrangements included within the spirit and scope of the appended claims. For example, although the preferred embodiment of the invention uses an iPod as the platform for the display and playback of linked data files having disparate data types, other hand-holdable devices for downloading and displaying or playing back information content may be used as a platform. The scope of the following claims is to be accorded the broadest interpretation so as to encompass all such modifications and equivalent structures and functions.

What is claimed is:

1. A system configured for receiving downloadable files, the system being hand-holdable, and the system comprising:
a data port for receiving a transfer of at least a first downloadable file and a second downloadable file;
a link module for linking the first downloadable file to the second downloadable file;
an audio output port for playback of audio data; and
a user interface for displaying visible data,
wherein each of the first and second downloadable files includes a data type selected from the group consisting of audio data, text data, image data, and video data, and wherein the data type included in the first downloadable file is not the same as the data type included in the second downloadable file.

2. The system of claim 1, wherein the system includes an iPod.

3. The system of claim 1, wherein each of the at least first and second downloadable files includes data relating to a common subject.

4. The system of claim 3, wherein the common subject is selected from the group consisting of a travel guide, a nature and field guide, a restaurant guide, an entertainment guide, a medical reference guide, a professional training guide, and a study guide relating to a university course.

5. The system of claim 3, wherein the user interface is configured to display an icon relating to the common subject and to enable a user to select the icon,
wherein when a user selects the icon, the user interface is further configured to display selectable items, each selectable item relating to one of the at least first and second downloadable files.

6. The system of claim 5, wherein when a user selects a selectable item relating to a downloadable file that includes audio data, the system is configured to play back the audio data via the audio output port; and
when a user selects a selectable item relating to a downloadable file that includes text data or image data, the system is configured to display the text data or image data via the user interface; and
when a user selects a selectable item relating to a downloadable file that includes video data, the system is configured to play back the video data via the user interface.

7. A method of providing data to a user, the data comprising at least two data types selected from the group consisting of audio data, text data, image data, and video data, the data relating to a common subject, and the method comprising the steps of:
deriving a first data file having a first data type from the data relating to the common subject;
deriving a second data file having a second data type from the data relating to the common subject, the second data type being different than the first data type;
combining the first and second data files into a single combined file;
extracting the first and second data files from the combined file;
downloading the first and second data files to a hand-holdable device;
enabling a user to use the hand-holdable device to select the common subject; and
when the common subject is selected, providing access to the data included in each of the first and second data files via the hand-holdable device.

8. The method of claim 7, the method further comprising the steps of:
deriving a third data file having a third data type from the data relating to the common subject, the third data type being different than each of the first data type and the second data type;
combining the third data file with the first and second data files into the single combined file;
extracting the third data file from the combined file;
downloading the third data file to the hand-holdable device; and
when the common subject is selected, providing access to the data included in the third data file via the hand-holdable device.

9. The method of claim 8, the method further comprising the steps of:
deriving a fourth data file having a fourth data type from the data relating to the common subject, the fourth data type being different than each of the first, second, and third data types;
combining the fourth data file with the first, second, and third data files into the single combined file;
extracting the fourth data file from the combined file;
downloading the fourth data file to the hand-holdable device; and
when the common subject is selected, providing access to the data included in the fourth data file via the hand-holdable device.

10. The method of any of claim 7, claim 8, or claim 9, wherein the data files are downloaded to an iPod, and wherein the step of providing access to the data is performed using the iPod.

11. The method of any of claim 7, claim 8, or claim 9, wherein the common subject is selected from the group consisting of a travel guide, a nature and field guide, a restaurant guide, an entertainment guide, a medical reference guide, a professional training guide, and a study guide relating to a university course.

12. The method of claim 7, the method further comprising the steps of:
displaying an icon relating to the common subject;
enabling the user to select the icon; and
when the icon is selected, displaying selectable items, each selectable item relating to one of the first and second data files.

13. The method of claim 12, wherein the step of providing access to the data further comprises the following steps:
when a selectable item relating to a downloadable file that includes audio data is selected, playing back the audio data; and
when a selectable item relating to a downloadable file that includes text data or image data is selected, displaying the text data or image data; and
when a selectable item relating to a downloadable file that includes video data is selected, playing back the video data.

14. A storage medium for storing software for providing data to a user, the data comprising at least two data types selected from the group consisting of audio data, text data, image data, and video data, the data relating to a common subject, the software being readable by a microprocessor, and the software including instructions for causing a microprocessor to:
download a first data file, the first data file including a first data type, and the first data file including data relating to the common subject;
download a second data file, the second data file including a second data type and the second data type being different than the first data type, and the second data file including data relating to the common subject;
link the first data file to the second data file;
enable a user to choose the common subject; and
when the common subject is chosen, provide access to the data included in each of the first and second data files.

15. The storage medium of claim 14, the software further including instructions for causing a microprocessor to download a third data file, the third data file including a third data type and the third data type being different than each of the first data type and the second data type, and the third data file including data relating to the common subject.

16. The storage medium of claim 15, the software further including instructions for causing a microprocessor to download a fourth data file, the fourth data file including a fourth data type and the fourth data type being different than each of the first data type, the second data type, and the third data type, and the fourth data file including data relating to the common subject.

17. The storage medium of any of claim 14, claim 15, or claim 16, wherein the microprocessor is configured to download the data files to an ipod, and wherein the microprocessor is further configured to provide access to the data by using the iPod.

18. The storage medium of any of claim 14, claim 15, or claim 16, wherein the common subject is selected from the group consisting of a travel guide, a nature and field guide, a restaurant guide, an entertainment guide, a medical reference guide, a professional training guide, and a study guide relating to a university course.

19. The storage medium of claim 14, the software further including instructions for causing a microprocessor to:
create a display of an icon relating to the common subject;
enable the user to select the icon; and
when the icon is selected, create a display of selectable items, each selectable item relating to one of the first and second data files.

20. The storage medium of claim 19, the software further including instructions for causing a microprocessor to execute the following actions:
when a selectable item relating to a downloadable file that includes audio data is selected, play back the audio data; and
when a selectable item relating to a downloadable file that includes text data or image data is selected, display the text data or image data; and
when a selectable item relating to a downloadable file that includes video data is selected, play back the video data.

21. An iPod adapted for receiving linked downloadable files, each of the linked files including data that is related to a common subject, and the iPod comprising:
a data port for receiving a transfer of at least a first downloadable file and a second downloadable file;
a link module for linking the first downloadable file to the second downloadable file;
an audio output port for playback of audio data; and
a user interface for displaying visible data,
wherein each of the first and second downloadable files includes a data type selected from the group consisting of audio data, text data, image data, and video data, and wherein the data type included in the first downloadable file is not the same as the data type included in the second downloadable file; and
wherein the user interface is configured to display an icon relating to the common subject and to enable a user to select the icon, and
wherein, when a user selects the icon, the user interface is further configured to display a plurality of selectable links, each of the plurality of selectable links relating to one of the data types included in the at least two downloadable files, and
wherein when a user selects a selectable link relating to a downloadable file that includes audio data, the iPod is configured to play back the audio data via the audio output port; and
when a user selects a selectable link relating to a downloadable file that includes text data or image data, the system is configured to display the text data or image data via the user interface; and
when a user selects a selectable link relating to a downloadable file that includes video data, the system is configured to play back the video data via the user interface.

22. A method of providing data via an iPod to a user, the data comprising at least two data types selected from the group consisting of audio data, text data, image data, and video data, the data relating to a common subject, and the method comprising the steps of:
deriving at least a first data file having a first data type and a second data file having a second data type different from the first data type from the data relating to the common subject;
combining the at least first and second data files into a single combined file;
extracting the at least first and second data files from the combined file;
downloading the at least first and second data files to the iPod;
displaying an icon relating to the common subject;
enabling a user to use the iPod to select the icon; and
when the icon is selected, displaying selectable links, each selectable link relating to one of the downloaded data files; and
when a selectable link relating to a downloaded data file that includes audio data is selected, playing back the audio data; and
when a selectable link relating to a downloaded data file that includes text data or image data is selected, displaying the text data or image data; and
when a selectable link relating to a downloaded file that includes video data is selected, playing back the video data.

23. A storage medium for storing software for providing data via an iPod to a user, the data comprising at least two data types selected from the group consisting of audio data, text data, image data, and video data, the data relating to a common subject, the software being readable by a microprocessor, and the software including instructions for causing a microprocessor to:
download at least a first data file having a first data type and a second data file having a second data type, the second data type being different than the first data type, and each of the at least first and second data files including data relating to the common subject;
combine the at least first and second data files into a single combined file;
use the combined file to install the at least first and second data files onto the iPod;
enable a user to use the iPod to select an icon relating to the common subject; and
when the icon is selected, provide access to the data included in each of the at least first and second data files via the iPod.
